(19) United States
(12) Patent Application Publication
(10) Pub. No.: US 2007/0258262 A1
(43) Pub. Date: Nov. 8, 2007

(54) Independent, self-contained readable-panel lighting system

(76) Inventor: Michael Hanyon, Pleasant Grove, UT (US)

Correspondence Address: PATE PIERCE & BAIRD, 215 SOUTH STATE STREET, SUITE 550, PARKSIDE TOWER, SALT LAKE CITY, UT, 84111, US

(21) Appl. No.: 11/417,275

(22) Filed: May 3, 2006

(51) Int. Cl. F21V 7/04; G01D 11/28; G08B 5/00; B60Q 1/26

(52) U.S. Cl. 362/600; 340/815.4; 362/23; 340/468

(57) ABSTRACT

An apparatus for lighting a readable panel is disclosed in one embodiment in accordance with the invention as including a lighting system for generating light independent of the electrical system of a mobile platform. Such a lighting system may include a light source, an energy storage device to supply electrical energy to the light source, and a power generator to charge the energy storage device. A mounting system may be used to attach the lighting system to the panel, a frame of the panel, a mount for mounting the panel, an area proximate the panel, or the like.

### BACKGROUND

1. The Field of the Invention

This invention relates to independent lighting systems and more particularly to lighting systems for illuminating readable panels or signage inaccessible or hard to reach using conventional infrastructure or mobile platform electrical systems such as building and vehicle power sources.

2. Background

Lighting systems provide the ability for night operations of many persons in many activities. However, lighting may be insufficient or unreliable in locations remote from generators or power lines. Remote from the infrastructure of utilities (e.g. power) or vehicle power sources, lighting may need to be self-contained.

For example, in an effort to aid law enforcement officers or other officials in identifying, tracking, and regulating motor vehicles, both in daylight and in darkness, state and federal laws and regulations require vehicles to adequately light readable panels such as vehicle license plates. Many jurisdictions, for example, require at least one white light mounted at the rear of a vehicle such that a license number may be clearly read at a specified distance, such as fifty feet. Some jurisdictions permit some flexibility in meeting the license plate requirement, including permitting the license plate light to be part of a tail lamp assembly attached to a vehicle.

For most vehicles, mounting and running power to a vehicle license plate light is routine. That is, a light may be mounted at or near a vehicle license plate, and wiring, conduit, and the like may be routed to the license plate light in the same way it is routed to tail, brake, and clearance lights. These lights may be powered by the vehicle electrical system, including a battery and an alternator or generator to keep the battery charged. Furthermore, the license plate light may be protected from damage by a cover, vehicle bumper, or other vehicle feature. The light may be mounted an adequate height above the road surface where damage is unlikely. Furthermore, because most vehicles are driven on paved roads or highways that are free of significant debris, damage caused by rocks or other debris kicked-up may be unlikely and infrequent.

However, satisfying lighting requirements, such as the license plate lighting requirement, may be difficult for certain types of vehicles or mobile platforms. For example, standard dump trucks, which include a dump body and tailgate, may lack a satisfactory location to mount a license plate and associated license plate light. If a license plate is mounted to the tailgate, which typically swings from dump body on hinges at the top of the dump body, it is difficult if not impossible to route wires or a conduit along or over these hinges to power a license plate light.

On the other hand, if a rear license plate is mounted to the frame of a dump truck below the tailgate, rock, gravel, or other payloads carried by a dump truck are likely to regularly damage the license plate light as they strike and bounce when dumped. Furthermore, although the sides of the dump body adjacent to the tailgate may be used to mount small tail or clearance lights, this area lacks sufficient width to mount a license plate. Thus, satisfying the license plate lighting requirement, although routine for some types of vehicles, is actually very problematic with other types of vehicles such as dump trucks.

The inability to adequately mount a license plate and associated light does not come without costs. The problem can lead to repeated law enforcement citations and time lost due to traffic stops and appearing in court to address non-compliance with the requirement. Because of the lack of an adequate solution, some dump truck operators must simply accept the resulting citations and lost time as costs of doing business.

In other situations, a real estate property may have no power on, or may not even have a power line installed yet. Also, a house may have a number installed in a location not reached by a porch light. Afterthoughts for signage anywhere may require aftermarket lighting sources that do not or cannot require or connect to a pre-installed power system. Whether a remote cabin, raw land, or a portion of a tractor truck or other vehicle subject to damage during duty, certain applications need “standalone” lighting systems. What is needed is a power generation system, a storage system, and a light source integrated together to serve inaccessible locations, particularly in the aforementioned applications.

In view of the foregoing, what is needed is a standalone, independent lighting system such as a license plate lighting system that overcomes many if not all of the above-mentioned problems. Specifically, a system is needed to provide illumination to signage generally, such as license plates in particular and other readable panels in locations where access to infrastructure power, such as wall power or a vehicle electrical system is unavailable or impracticable. Such a device would ideally be simple, self-contained, robust, and protect a light source from damage. Further, such a system could also be used to illuminate other types of vehicle components and signs, such as HAZMAT signs, or other aftermarket signage that are not easily or conveniently powered by a vehicle electrical system.

### BRIEF SUMMARY OF THE EMBODIMENTS

Consistent with the foregoing, and in accordance with the invention as embodied and broadly described herein, an apparatus for lighting a readable panel is disclosed in one embodiment in accordance with the invention as including a lighting system for generating light independent of the electrical system of a mobile platform. Such a lighting system may include a light source, an energy storage device to supply electrical energy to the light source, and a power generator to charge the energy storage device. A mounting system may be used to attach the lighting system to the panel, a frame of the panel, a mount for mounting the panel, an area proximate the panel, or the like.

An energy storage device for use with the present invention may include, for example, a battery, a capacitor, an inductor, a spring, a flywheel, a chemical system, a phase-changing material, or the like, and may be repeatedly rechargeable. To charge and recharge the energy storage device, a power generator may convert solar energy, motion energy, vehicle waste heat, vibration energy, wind energy or the like, to electrical energy. For example, sources may be solar panels, wind turbines, rotating generators, Faraday-effect devices, piezoelectric transducers, thermopiles, thermocouples, thermodynamic energy cycles, or other mechanisms to convert a source of energy to electric power.

Power provided to the energy storage device may then be used as needed to power a light source, such as one or more light bulbs, LEDs, or the like. Thus, in general, a standalone lighting system may include these elements and other supporting hardware, software, firmware, or controls as required. However, as an example, we will use vehicle lighting, recognizing that all of the features and components thereof can be applied to various other applications.

To conserve power, the apparatus may include a light sensor to interrupt the supply of electrical power to the light source during daylight hours. To further conserve power for times that a mobile platform is moving, the apparatus may also include a motion sensor to interrupt the supply of electrical power to the light source when the apparatus is stationary for a specified period. Likewise, for wind power, an anemometer may shut off power use upon detecting a lack of air movement for an extended period.

In certain embodiments, a lighting system in accordance with the invention may include a frame, also functioning as a housing, substantially enclosing the lighting system. The frame may, in certain embodiments, include a surface for mounting the readable panel and a cover to protect the light source.

In certain embodiments, the readability of the panel is a statutory requirement. A readable panel may include, for example, a HAZMAT warning, a license plate, a public service designation, a regulatory designation, a vehicle fleet identifier, or the like.

In another aspect in accordance with the invention, a method for lighting a panel on a mobile platform includes generating electrical energy independent from an electrical system of a mobile platform. The method further includes storing the electrical energy and supplying the electrical energy to a light source proximate the panel. Generating electrical energy may include, for example, converting solar energy, motion energy, and vibration energy to electrical energy. Storing the electrical energy may include, for example, storing the electrical energy using a battery, capacitor, inductor, spring, flywheel, chemical species, thermal reservoir, phase change, or the like.

In certain embodiments, the method includes interrupting the supply of electrical energy to the light source during daylight hours. Likewise, the method may also include interrupting the supply of electrical energy to the light source when the apparatus is stationary for a specified period.

In another embodiment of a system in accordance with the invention, an apparatus for lighting a license plate includes a lighting system for generating light independent of a vehicle electrical system. The light system may include a light source, an energy storage device to supply electrical energy to the light source, and a power generator to charge and recharge the energy storage device. A light sensor may be provided to control or interrupt the supply of electrical power to the light source during daylight hours. A mounting system may be used to attach the lighting system to a license plate, a license plate frame, a license plate mount, an area proximate a license plate, or the like.

### BRIEF DESCRIPTION OF THE DRAWINGS

The foregoing and other objects and features of the present invention will become more fully apparent from the following description and appended claims, taken in conjunction with the accompanying drawings. Understanding that these drawings depict only typical embodiments in accordance with the invention and are, therefore, not to be considered limiting of its scope, the invention will be described with additional specificity and detail through use of the accompanying drawings in which:

FIG. 1 is a rear perspective view of a dump truck showing one application of an apparatus in accordance with the invention;

FIG. 2 is rear elevation view of a dump truck showing one application of an apparatus in accordance with the invention;

FIG. 3A is a front elevation view of an independent, self-contained lighting system for use with signage such as a license plate;

FIGS. 3B through 3E are cutaway side elevation views of different embodiments of lighting systems in accordance with the invention;

FIG. 4A is a front elevation view of another embodiment of a lighting system for lighting a reflective or other sign, such as a license plate;

FIG. 4B is a cutaway side elevation view of the lighting system illustrated in FIG. 4A;

FIGS. 5A and 5B are high-level schematic block diagrams of various components for implementing a lighting system in accordance with the invention;

FIG. 6A is a front elevation view of another embodiment of a lighting system in accordance with the invention;

FIG. 6B is a cutaway side elevation view of the lighting system illustrated in FIG. 6A;

FIG. 7 is a front elevation view of another embodiment of a lighting system in accordance with the invention;

FIG. 8 is a front elevation view of another embodiment of a lighting system in accordance with the invention;

FIG. 9 is a front elevation view of one embodiment of a lighting system for lighting a readable panel such as a HAZMAT sign; and

FIG. 10 is a front elevation view of an alternative embodiment of the lighting system illustrated in FIG. 9.

### DETAILED DESCRIPTION OF THE EMBODIMENTS

It will be readily understood that the components of the present invention, as generally described and illustrated in the Figures herein, could be arranged and designed in a wide variety of different configurations. Thus, the following more detailed description of the embodiments of apparatus and methods in accordance with the present invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

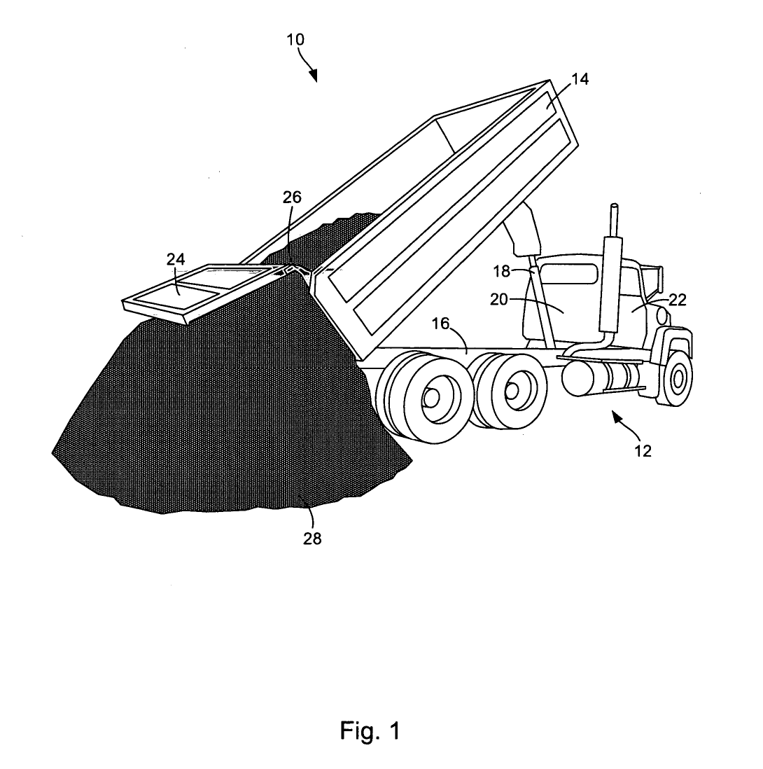

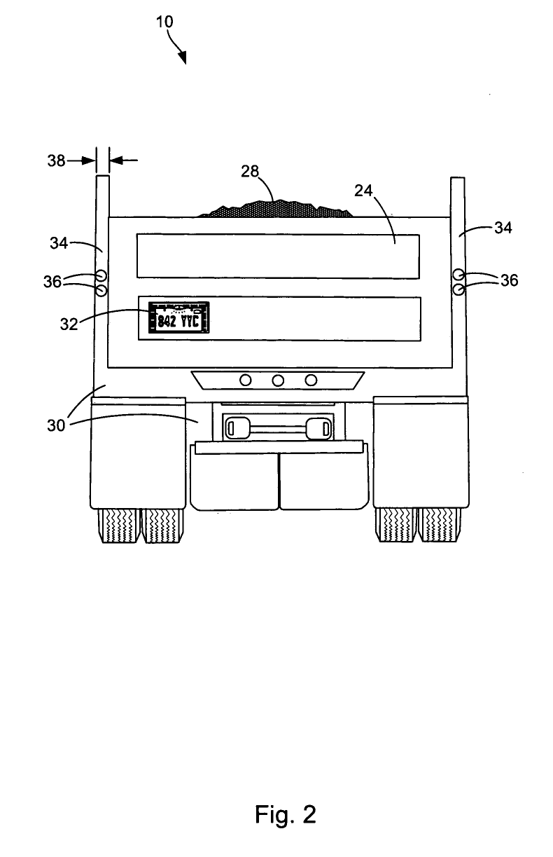

Referring to FIGS. 1 and 2, as previously mentioned herein, satisfying a readable-panel lighting requirement, such as a license plate lighting requirement, may be difficult for some types of vehicles 10, or mobile platforms 10. For the purposes of this description, the phrase “mobile platform” is used to mean any of various mobile structures, including but not limited to vehicles, barges, onshore and offshore drilling platforms, shipping containers, pallets, conveyance systems, or the like.

One will appreciate that the term “vehicle” may include various types conveyances for transporting people or objects, including but not limited to cars, trucks, trailers, motorcycles, snowmobiles, boats or other watercraft, aircraft, and all types of heavy equipment, to name just a few. Heavy equipment may include, for example, dump trucks, cranes, backhoes, bulldozers, excavators, graders, forklifts, and the like, to name a few.

Thus, apparatus and methods in accordance with the invention, although described in association with a dump truck herein, may be used with a wide variety of mobile platforms 10, including but not limited to those listed above. Moreover, stationary systems, such as houses, derricks, buildings, blockhouses, and the like may still use a system in accordance with the invention relying on solar or wind sources of energy rather than motion.

As illustrated, one type of mobile platform 10, a standard dump truck 10, may include a full truck chassis 12 with a dump body 14 mounted to a frame 16. The dump body 14 may be raised by a hydraulic ram 18 mounted behind a front bulkhead 20, between a truck cab 22 and the dump body 14. A tailgate 24 may be adapted to swing on hinges 26 or it can be provided in a “high lift tailgate” configuration (not shown) wherein pneumatic or hydraulic rams lift the tailgate 24 open and above the dump body 14. The tailgate 24 may be locked while traveling and unlocked prior to raising the dump body 14. As the payload is dumped from the dump body 12, the tailgate 24 may swing open and rest on the payload 28. Often, a tailgate 24 is corrugated or may incorporate one or more structural support beams to increase the strength and rigidity of the tailgate 24.

As previously mentioned, a dump truck 10 may lack a satisfactory location to mount a license plate 32 and associated license plate light. If a license plate 32 is mounted to the tailgate 24, it is difficult if not impossible to route wires or conduits along or over the hinges 26 to power a license plate light without severing or damaging the wires or conduits. Similarly, if a license plate 32 is mounted to the frame 30 or other structure 30 of the truck 10 below the tailgate 24, rock, gravel, or other payloads carried by a dump truck 10 are typically likely to damage the license plate 32 and associated light when dumped.

Furthermore, although sides 34 of the dump body 14 adjacent to the tailgate 24 may be used to mount small tail or clearance lights 36, this area almost always lacks sufficient width 38 to mount a license plate 32. Similarly, projecting the license plate 32 away from the dump body 14 makes it highly susceptible to damage. Thus, satisfying the license plate lighting requirement, although routine for many vehicles, can be very problematic with some types of vehicles 10 or mobile platforms 10, such as dump trucks 10. Thus, a lighting system is needed to provide illumination to license plates, as well as other readable panels, in locations where practical or convenient access to a mobile platform electrical system is unavailable.

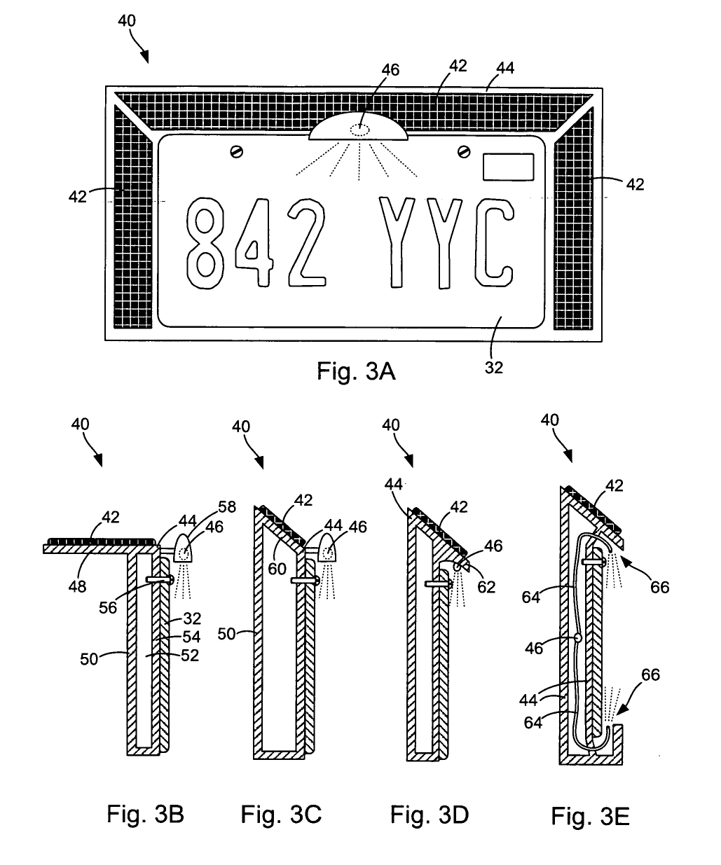

Referring to FIG. 3A, in one embodiment in accordance with the invention, an apparatus 40 for generating light independent of an electrical system of a mobile platform 10 may include one or more power generators 42, such as solar panels 42, mounted around a frame 44. A license plate 32 or other readable panel 32 may be mounted at or near the center of the frame 44. In certain embodiments, to maximize the amount of solar energy gathered, several solar panels 42 may be mounted around the outer boundary of the frame 44, such as along the top and sides of the frame 44. Similarly, a top solar panel 42 may be angled or aimed upward to gather additional solar rays. The solar panels 42 may be used to charge and recharge an energy storage device (not shown) for powering a light source 46. An energy storage device may include, for example, a battery, a capacitor, an inductor, a spring, a flywheel, or the like. Similarly, a light source may include, for example, a light bulb, an LED, or the like.

One advantage of the apparatus illustrated in FIG. 3A, as well as other embodiments illustrated herein, is their ability to illuminate conventional license plates and other readable panels mounted to mobile platforms 10. That is, it is unnecessary to modify, alter, or replace a license plate 32 or other readable panel 32 prior to using the lighting system. This provides a quick and easy installation which may be used to retrofit existing vehicular designations, such as license plates 32.

Referring to FIG. 3B, a frame 44 for supporting and housing an independent lighting system may take on various forms. For example, in one embodiment, a frame 44 may include a projection 48 extending from the rear surface 50 of the frame 44. The projection 48 may be used to rest on a corrugated surface or structural beam incorporated into a dump truck tailgate 24. A solar panel 42 may be mounted to the top surface of the projection 48. The projection 48 may serve several purposes. For example, the projection 48 may provide a surface for resting the apparatus 40 on the tailgate 24 prior to mounting. The projection 48 may also provide means for aligning the apparatus 40 with respect to the tailgate 24. Furthermore, the projection 48 may provide a wider area for mounting a larger solar panel 42. Because the top of the projection 48 faces substantially upward, this may increase exposure to and power generated from sunlight incident on the solar panel 42.

In certain embodiments, the frame 44 may be provided with a hollow region 52 to house components of the lighting system, thereby protecting the components from contaminants, damage, and weather. For example, an energy storage device used to power the light source 46, as well as other circuitry that will be described in more detail hereafter, may be housed in the hollow region 52. The frame 44 may also provide a surface 54 for mounting a license plate 32 or other signage 32 using one or more fasteners 56. As illustrated, a light fixture 58 housing the light source 46 may be mounted to the frame 44 and may project light onto the front surface of a reflective license plate 32 or other readable panel 32.

Referring to FIG. 3C, in another embodiment, a frame 44 may be provided with a substantially flat rear surface 50 to mount the frame 44 to a surface of a tailgate 24 or other substantially flat surface. A top surface 60 of the frame 44 may be angled upward to expose the solar panel 42 to additional sunlight.

Referring to FIG. 3D, in another embodiment, an overhang 62 maybe incorporated into the frame 44 to cover and protect a light source 46. This overhang 62 may eliminate the need for a separate light fixture 58 and may simplify the overall design. For example, the overhang 62, as well as the rest of the frame 44, may be monolithically formed, such as through an extrusion process. Because an overhang 62 may extend along the length of the frame 44, several light bulbs 46 or LEDs 46 may be mounted under the overhang 62 along the length of the frame 44, providing additional and better lighting distribution. Furthermore, like the projection 48 illustrated in FIG. 3B, the overhang 62 may provide a wider area for mounting a larger solar panel 42, thereby increasing exposure to sunlight.

Referring to FIG. 3E, in yet another embodiment, optical fibers 64 may be used to transport light from a centrally or remotely located light source 46. These optical fibers 64 may be routed to various positions along the top, bottom, and sides of a license plate 32 or other readable panel 32. One contemplated advantage of this embodiment is that a light source 46 may be housed and protected within the frame 44 rather than being located in a more exposed position. Furthermore, several optical fibers 64 may be routed from a single light source 46, potentially reducing the number of light sources 46 needed. To implement such an embodiment, openings 66 may be provided at the top, bottom, and/or sides of the frame 44 to receive, support, and hold one or more optical fibers 64 and to direct light onto desired regions of a license plate 32 or other readable panel 32 (e.g. signage 32).

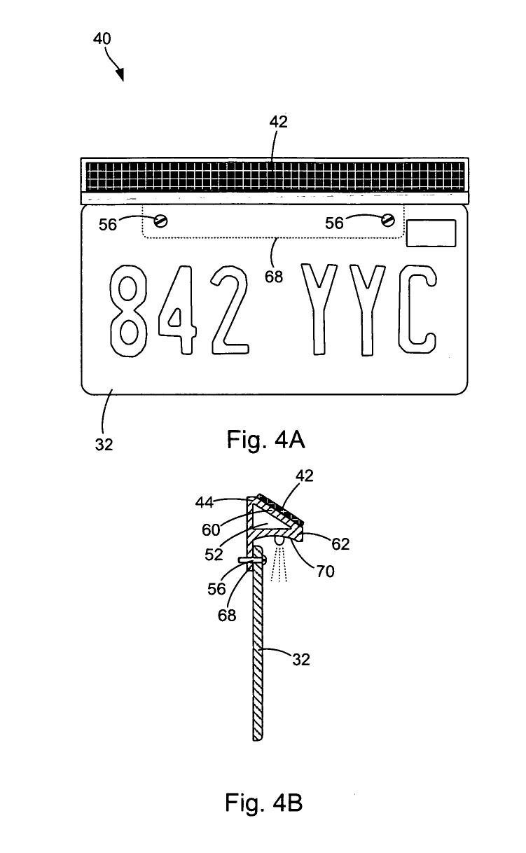

Referring to FIGS. 4A and 4B, in another embodiment, an apparatus 40 in accordance with the invention may be attached to a tailgate 24, or other structure, using the same fasteners used to attach a license plate32 or other readable panel 32 to a tailgate 24 or elsewhere. This embodiment may be used to retrofit existing license plates 32 or provide a simple and compact solution for independently lighting a readable panel 32.

For example, in one embodiment, a frame 44 may include a flange 68 to extend behind, or alternatively in front of, a license plate 32 or other readable panel 32. One or more fasteners 56 may extend through the readable panel 32 and the flange 68, thereby clamping the panel 32 and the flange 68 to another structure, such as the tailgate 24 of a dump truck.

Like other embodiments, the frame 44 may include a hollow region 52 to house circuitry and other components, such as an energy storage device. Similarly, the frame 44 may also include an angled surface 60 to accommodate a solar panel 42 and to increase the solar panel's exposure to sunlight. In certain embodiments, the frame 44 may provide an overhang 62 and light sources 46, such as light bulbs 46 or LEDs 46, may be mounted underneath the overhang 62. This may protect the light source 46 and eliminate or reduce the need for separate light fixtures.

It is also contemplated that the bottom surface 70 of the overhang 62 may be provided with a reflective coating to aid in directing light onto the panel 32. Although the illustrated embodiment includes only a single solar panel 42 along the top of the frame 44, it is contemplated that in other embodiments, solar panels 42 may be mounted along the sides of the panel 32, as illustrated in FIG. 3A, while still retaining the simple retrofit design illustrated in FIGS. 4A and 4B.

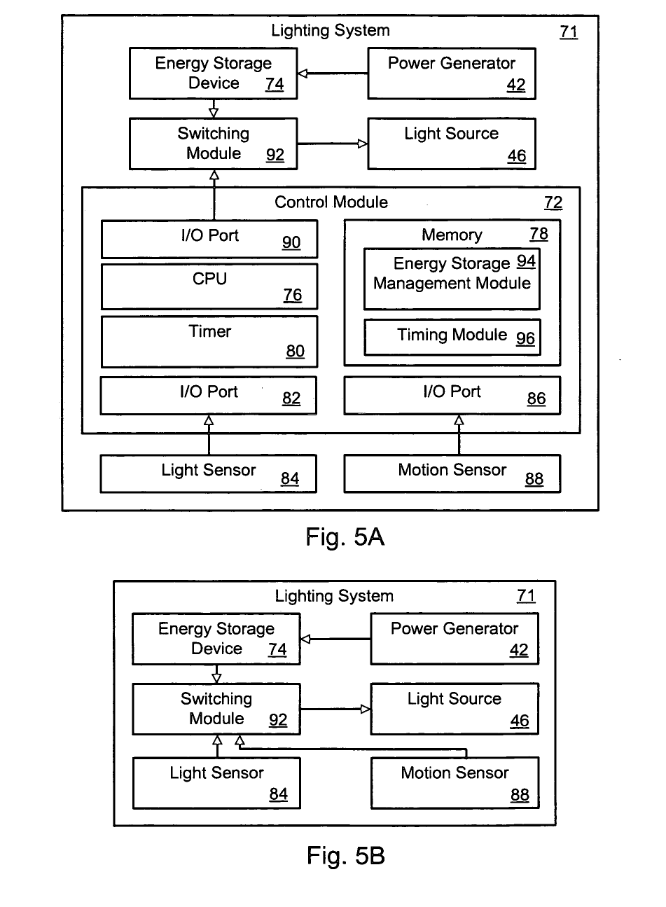

Referring to FIG. 5A, in one embodiment, an independent lighting system 71 for use with an apparatus 40 in accordance with the invention may include a control module 72 for controlling the light source 46, managing an energy storage device 74, controlling timing of the light source 46, and the like. In one embodiment, a control module 72 may include, among other components, a CPU 76, memory 78, a timer 80, and the like, known to those of skill in the art. Memory 78 may include, for example, ROM, EEPROM, RAM, and the like, to store executable code and operational data for controlling the lighting system 71.

In certain embodiments, the control module 72 may include an I/O port 82 to receive input from a light sensor 84 and an I/O port 86 for receiving input from a motion sensor 88. Similarly, the control module 72 may include an I/O port 90 to control a switching module 92. A switching module 42 may include, for example, transistors, relays, or other types of switches for selectively interrupting (i.e., switching on and off) power supplied to a light source 46.

In operation, a control module 72 may receive input from a light sensor 84 to monitor light intensity. When the light intensity is above a certain level, such as during daylight hours, the control module 72 may interrupt power supplied to the light source 46 by opening the circuit (i.e., using the switching module 92) to cut off power to the light source 46. Conversely, when the light intensity falls below a certain level, particularly for a specified time, the control module 72 may close the circuit, thereby supplying power to the light source 46. In certain embodiments, the control module 72 may be configured to control the light source 46 according to the light intensity measured over a period of time. In this way, a temporary increase in light intensity measured by the light sensor 84, such as might occur if another vehicle were to momentarily shine its headlights on the light sensor 84, would not automatically turn off the light source 46.

Similarly, a motion sensor 88 may be used to interrupt power supplied to a light source 46 when a vehicle 10 or other mobile platform 10 is stationary. For example, because a light source 46 may be primarily needed when a vehicle 10 is moving, a motion sensor 88 may be used to monitor a vehicle's movement. If a vehicle 10 is stationary for a certain amount of time (e.g., ten minutes), the control module 72 may interrupt the supply of power to the light source 46, even during nighttime hours.

Similarly, if the vehicle 10 begins to move, the power supply may be immediately re-supplied (i.e., switched on). Such a feature may be used to conserve energy and to turn off a light source 46 in the event a vehicle 10, such as a dump truck, has been parked for a time or retired for the evening. By conserving energy stored in the energy storage device 74, additional power may be available when needed most, or a smaller power generator 42 may be used. Additional power may also be used to power a brighter light source 46.

A control module 72 may provide various sophisticated functions to the lighting system 71. For example, an energy storage management module 94 may vary power output to the light source 46. For example, where solar panels are used to charge the energy storage device 74, the energy storage device 74 may be charged to different levels on sunny days as opposed to overcast days, or summer days as opposed to winter days. To adjust for varying conditions, the energy storage management module 94 may adjust the amount of power delivered to the light source 46 depending on the amount of energy stored. Thus, a light source 46 may be dimmed, turned off at an earlier time, or some light sources 46 may be turned off altogether, while others are kept on, to conserve energy and to adjust for regional, seasonal, or meteorological variations.

In other embodiments, the control module 72 may include a timing module 96 to control the timing of power supplied to the light source 46. For example, a vehicle 10, such as a dump truck 10, may only be operated until a certain time at night or on certain days of the week. Thus, a timing module 96 may be used to turn off the power supply after a specified time (e.g., midnight) or on certain days of the week (e.g., Saturdays or Sundays). Thus, certain embodiments of a timing module 96 may keep or work in conjunction with a system clock to turn power on and off.

In certain embodiments, a timing module 96 may use a motion sensor 88 to monitor movement of a vehicle 10 or other mobile platform. The timing module 96 may then be used to calculate a regular time of use of the vehicle 10 and adjust the timing of the power supplied to the light source 46 accordingly. In other embodiments, a timing module 96 may simply wait a specified period before turning on or off the power supply to the light source 46. For example, as the sun rises in the morning hours, the timing module 96 may wait a specified period (e.g., fifteen minutes) before turning off the light source 46 to ensure a license plate 32 or other readable panel 32 is lit during the transition period from night to day.

Various options and alternatives for each of the components 42, 46, 72, 74, 76, 78, 80, 82, 84, 86, 88, 90, 92, 94, 96 are available to those of skill in the art and may be provided, for example, by various off-the-shelf microcontrollers, discrete components, FPGAs, ASICs, or the like. One of ordinary skill in the art will also recognize that functionality for implementing the above-disclosed system may be provided by hardware, software, firmware, or combinations thereof.

Referring to FIG. 5B, in another embodiment, a simpler, less sophisticated version of a lighting system 71 may leave out much of the functionality of the control module 72 described in association with FIG. 5A. For example, in one embodiment of a lighting system 71, a light sensor 84, motion sensor 88, or both, may directly, or more directly, control the switching module 92. Thus, a light sensor 84, a motion sensor 88, or both, may interface with the switching module 92 to open and close the circuit supplying power to the light source 46. One of ordinary skill in the art will recognize that the lighting system 71 may be designed in various ways and with different features. For example, U.S. Pat. No. 6,120,165 to Shalvi and U.S. Pat. No. 6,573,659 B2 to Toma et al., herein incorporated by reference, describe various lighting systems 71 that may be used in whole or in part in a lighting system 71 in accordance with the invention.

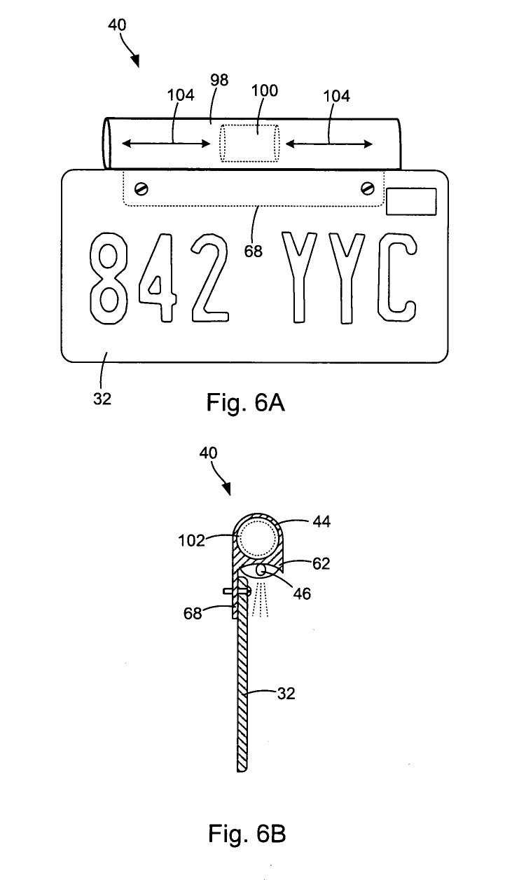

Referring to FIGS. 6A and 6B, in another embodiment in accordance with the invention, an apparatus 40 for generating light independent of a vehicle or mobile platform electrical system may include a generator 98 for converting motion or vibration energy to electrical energy. Because many vehicles 10, including dump trucks, are constantly vibrating, swaying, shaking, or otherwise moving during operation, such a generator 98 may be an ideal source of power for illuminating a license plate 32 or other readable panel 32.

For example, in one embodiment, a generator 98 for converting motion or vibratory energy to electrical energy may include a centrally located mass 100, comprising one or more magnets, moving through an inductance loop along an axis 104 in response to vibration, swaying, movement, or the like. Generators 98 for converting vibratory motion to electrical energy are disclosed, for example, in U.S. Pat. No. 5,578,877 to Tiemann and U.S. Pat. No. 6,994,450 B2 to Mah, which are herein incorporated by reference.

In general, the mass 100 (e.g. core, magnet, etc.) may pass through one or more coils of wire which may remain relatively stationary relative to the frame 44. This principle of relative motion between a field and a coil forms the basis for most, if not all, modern electric motors, generators, and transformers. As the mass 100 passes back and forth inside the cavity 102 and through the coils of wire, a current may be induced in the coils. This current may then be stored in an energy storage device 74, such as a capacitor or battery, to power a light source 46. Components that may improve the efficiency and performance of a lighting system 71 may include the quality of the light source 46 (in terms of brightness and efficiency), the strength of magnets moving through the coils, the number of windings in the coils, and the quality and size of the energy storage device 74 for storing the charge.

A generator 98 may be positioned in various orientations to convert either vertical, lateral, horizontal, (e.g., side to side), or transverse motion (e.g., front to back) into electrical energy. Furthermore, in certain embodiments, the mass 100 may be suspended or positioned in the cavity 102 with biasing members, such as springs, bumpers, or the like. These may be used to conserve the momentum of the mass 100 as it travels or vibrates back and forth in the directions 104.

In other embodiments, relative air motion (e.g. wind) may operate to rotate a wheel from a soft propeller, pinwheel, or the like. Likewise, a tube or duct may protect a fan, turbine, or the like that turns in response to air passing by a moving vehicle or wind passing a stationary object. By either means, such motion of air may drive a generator which stores power in a storage device, such as a battery. New technology using LEDs and highly reflective bead-filled paints may provide substantial illumination from modest power sources.

Like the embodiment described in association with FIGS. 4A and 4B, the frame 44 may include a flange 68 to extend behind, or alternatively in front of, a license plate 32 or other readable panel 32. This flange 68 may be used to clamp the panel 32 and the flange 68 to another structure, such as the tailgate 24 of a dump truck. As mentioned, the frame 44 may include a cavity 102 to accommodate travel of the mass 100, as well as house circuitry and other components, such as an energy storage device 74. In certain embodiments, the frame 44 may provide an overhang 62. Light sources 46, such as light bulbs 46 or LEDs 46, may be mounted beneath the overhang 62.

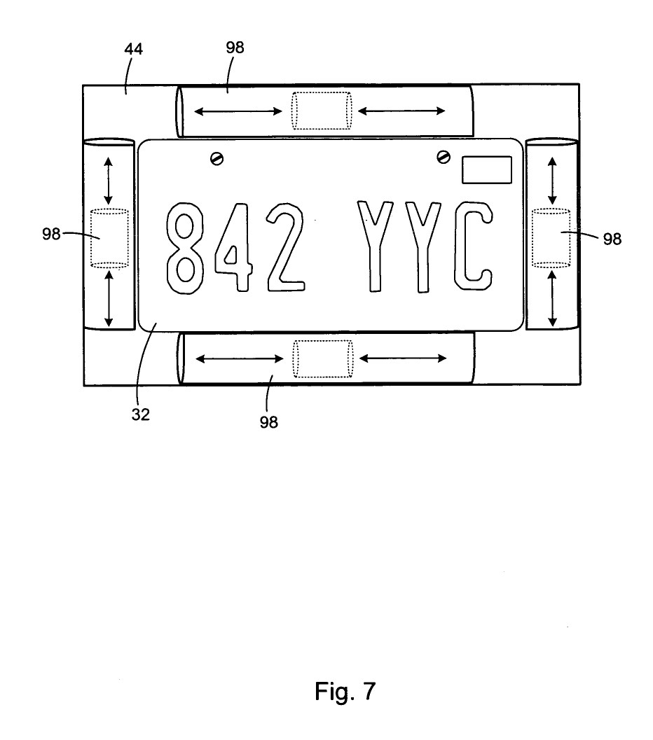

Referring to FIG. 7, in certain embodiments, one or more generators 98 for converting motion, wind, vehicle, or vibratory energy to electrical energy may be mounted along the border of a license plate 32 or other readable panel 32. The position and orientation of the generators 98 may be varied to absorb vertical, horizontal, and transverse vibrations and to provide redundancy in the event one or more of the generators 98 fails. For example, vertically oriented generators 98 may be used to primarily convert vertical motion and vibrations to electrical energy. Likewise, horizontally mounted generators 98 may be used to absorb horizontal vibrations. In certain embodiments, the generators 98 may each be mounted to or incorporated into a frame 44 which may also provide a surface for mounting a sign, such as a license plate 32.

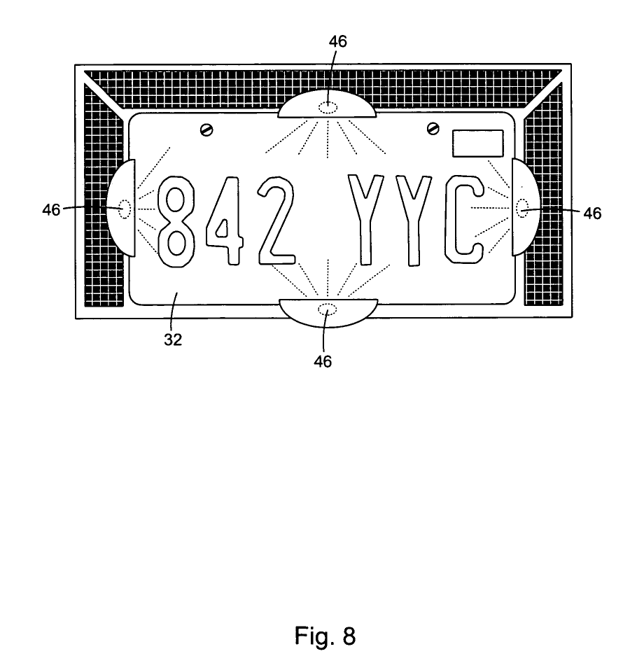

Referring to FIG. 8, in certain embodiments, multiple light sources 46 may be mounted around a license plate 32 or other readable panel 32. These light sources 46 may be mounted along the top or sides of a license plate 32. Such a configuration may be advantageous where using a single light is inefficient or inadequate to light a license plate. Multiple LEDs, for example, may be more inefficient and provide better lighting than a single higher-power LED. Furthermore, when power is low, one or more of the light sources 46 may be turned off to conserve power and to extend the life of an energy storage device 74.

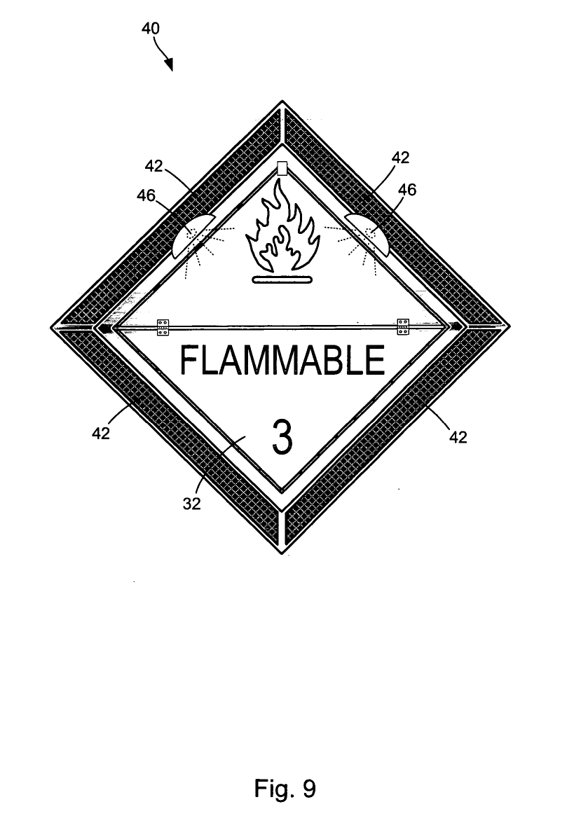

Referring to FIG. 9, although this specification primarily describes a lighting system for use with a license plate 32, an independent lighting system in accordance with the invention may be used with a wide variety of readable panels 32 mounted on different types of remote or mobile platforms 10 and vehicles 10. Thus, the apparatus 40 described herein is not limited to license plates 32, but to readable panels 32 of all types, including, for example, public service designations, regulatory designations, vehicle fleet identifiers, and the like, mounted to mobile platforms 10 of all types. Thus, each of these applications are within the scope of the present invention.

For example, in certain embodiments an apparatus 40 for generating light independent of a mobile platform electrical system may be used to illuminate HAZMAT (i.e., hazardous material) signs 32. HAZMAT signs 32, like many other readable panels 32, are often inaccessible or inconveniently accessible by the electrical systems of mobile platforms 10. An aftermarket sign may not have access to built-in lighting sources. Like other embodiments described herein, in certain embodiments, one or more solar panels 42 or cells 42 may be mounted around the periphery of a HAZMAT sign 32. These solar panels 42 may be used to charge and recharge an energy storage device 74 used to power one or more light sources 46 mounted around the sign 32.

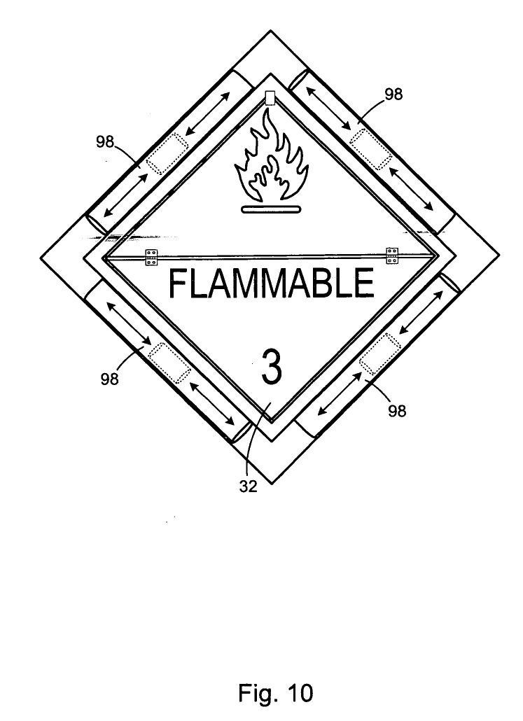

Similarly, referring to FIG. 10, in certain embodiments, one or more generators 98 for converting motion or vibratory energy to electrical energy may be mounted around a HAZMAT sign 32. These generators 98 may be positioned in various orientations to convert either vertical, horizontal, or transverse motion or vibration, or combinations thereof, into electrical energy. This energy may be used to charge and recharge an energy storage device 74 to power one or more light sources 46 around the sign 32. Lighting may be enhanced if signage is formed of beaded, reflective material or the “cube corner” reflective materials commonly seen in vehicle reflectors.

The present invention may be embodied in other specific forms without departing from its basic features or essential characteristics. The described embodiments are to be considered in all respects only as illustrative, and not restrictive. The scope of the invention is, therefore, indicated by the appended claims, rather than by the foregoing description. All changes within the meaning and range of equivalency of the claims are to be embraced within their scope.

What is claimed and desired to be secured by United States Letters Patent is:

1. An apparatus for lighting a panel on a mobile platform, the panel inaccessible by conventional wiring of the mobile platform and readable by an observer, the apparatus comprising:
a lighting system for generating light independent of a mobile platform electrical system, the lighting system comprising:
a light source;
an energy storage device coupled to and adapted to supply electrical energy to the light source; and
a power generator coupled to and adapted to charge the energy storage device; and
a mounting system for attaching the lighting system to at least one of the panel, a frame of the panel, a mount for mounting the panel, and an area proximate the panel.

2. The apparatus of claim 1, wherein the energy storage device is selected from the group consisting of a battery, a capacitor, an inductor, a spring, and a flywheel.

3. The apparatus of claim 2, wherein the storage device is repeatedly rechargeable.

4. The apparatus of claim 3, wherein the power generator converts at least one of solar energy, motion energy, and vibration energy to electrical energy.

5. The apparatus of claim 4, wherein the light source is selected from the group consisting of a light bulb and an LED.

6. The apparatus of claim 5, further comprising a light sensor to interrupt the supply of electrical power to the light source when light intensity rises above a specified level.

7. The apparatus of claim 6, further comprising a motion sensor to interrupt the supply of electrical power to the light source when the apparatus is stationary for a specified period.

8. The apparatus of claim 7, further comprising a housing substantially enclosing the lighting system.

9. The apparatus of claim 8, wherein the housing further comprises a surface for mounting the panel.

10. The apparatus of claim 9, wherein the readability of the panel is a statutory requirement.

11. The apparatus of claim 10, wherein the panel is selected from the group consisting of a HAZMAT warning, a license plate, a public service designation, a regulatory designation, and a vehicle fleet identifier.

12. The apparatus of claim 1, wherein the power generator converts at least one of solar energy, motion energy, and vibration energy to electrical energy.

13. The apparatus of claim 1, further comprising a light sensor to interrupt the supply of electrical power to the light source when light intensity rises above a specified level.

14. The apparatus of claim 1, further comprising a motion sensor to interrupt the supply of electrical power to the light source when the apparatus is stationary for a specified period.

15. A method for lighting a panel on a mobile platform, the panel inaccessible by conventional wiring of the mobile platform and readable by an observer, the method comprising:
generating electrical energy independent from a mobile platform electrical system;
storing the electrical energy; and
supplying the electrical energy to a light source proximate the panel, the light source illuminating the panel.

16. The method of claim 15, wherein generating electrical energy comprises at least one of converting solar energy, motion energy, and vibration energy to electrical energy.

17. The method of claim 15, wherein storing the electrical energy comprises storing the electrical energy using at least one of a battery, a capacitor, an inductor, a spring, and a flywheel.

18. The method of claim 15, further comprising interrupting the supply of electrical energy to the light source when light intensity rises above a specified level.

19. The method of claim 15, further comprising interrupting the supply of electrical energy to the light source when the apparatus is stationary for a specified period

20. An apparatus for lighting a license plate, the apparatus comprising:
a lighting system for generating light independent of a vehicle electrical system, the lighting system comprising:
a light source;
an energy storage device coupled to and adapted to supply electrical energy to the light source;
a power generator coupled to and adapted to charge the energy storage device; and
a light sensor to interrupt the supply of electrical power to the light source when light intensity rises above a specified level; and
a mounting system for attaching the lighting system to at least one of a license plate, a license plate frame, a license plate mount, and an area proximate a license plate.
